(19) United States
(12) Patent Application Publication
(10) Pub. No.: US 2012/0282446 A1
(43) Pub. Date: Nov. 8, 2012

(54) CARBON MATERIALS, PRODUCT COMPRISING THE SAME, AND METHOD FOR PREPARING THE SAME

(75) Inventors: Han Ik JO, Jeollabuk-do (KR); Sung Ho LEE, Jeollabuk-do (KR); Bon Cheol KU, Jeollabuk- do (KR); Jun Kyung KIM, Seoul (KR); Tae Wook KIM, Gyeonggi-do (KR); Sang Youp HWANG, Seoul (KR)

(73) Assignee: KOREA INSTITUTE OF SCIENCE AND TECHNOLOGY, Seoul (KR)

(21) Appl. No.: 13/292,326

(22) Filed: Nov. 9, 2011

(30) Foreign Application Priority Data
May 3, 2011 (KR) 10-2011-0041907

(51) Int. Cl. C01B 31/02; B32B 9/00; B05D 3/02; B05D 3/06; B05D 7/00; C01B 31/04; B05D 3/10; B82Y 30/00; B82Y 40/00

(52) U.S. Cl. 428/216; 428/333; 427/228; 427/488; 427/496; 427/508; 977/842; 977/734

(57) ABSTRACT

Provided is a preparation method for carbon materials, carbon materials prepared from the same, and a product including the carbon materials, in which the preparation method including forming a polymer layer containing a polymer, stabilizing the polymer layer to form a cyclized aromatic structure of carbon atoms in the polymer, and carbonizing the stabilized polymer layer.

### CROSS-REFERENCE TO RELATED APPLICATION

This application claims priority to Korean Patent Application No. 10-2011-0041907, filed on May 3, 2011, and all the benefits accruing therefrom under 35 U.S.C. §119, the contents of which in its entirety are herein incorporated by reference.

### BACKGROUND

1. Field

The present disclosure relates to carbon materials, a product comprising the same, and a method for preparing the same.

2. Description of the Related Art

Due to excellent physical and chemical characteristics, carbon materials as nanomaterials are used in a wide range of industrial applications. Particularly, carbon materials, such as graphene, graphite, carbon nanotube, fullerene, etc., have been noted as materials for electrical/electronic elements, optical elements, filter elements, and so forth.

Graphene has a planar (two-dimensional) sheet structure of carbon atoms arranged on a hexagonal lattice, resembling a honeycomb. Graphite has a one-dimensional structure consisting of a stack of two-dimensional graphene planes. Compared with other carbon materials such as one-dimensional graphite or carbon nanotubes, or zero-dimensional fullerene, graphene is superior in electrical characteristics and elasticity as well as metallicity and thermal conductivity, and thus has been noted as advanced materials for the future.

The single-layered graphene film that has been reported is known to have much more useful characteristics than any other carbon materials, for example, about 2600 m²/g in surface area and about 15,000 to about 200,000 cm²/Vs in electron mobility. The electron mobility in the graphene film, particularly, approaches the luminous flux, because electrons flow as weightless inside the graphene film.

Generally, graphene is fabricated in the form of a film by a Scotch tape method, an epitaxy method using a silicon carbide insulator, a chemical method using a reducing agent, and a method using a metallic catalyst.

The Scotch tape method is physically peeling a graphene film off a chunk of graphite using a cohesive tape. This method provides an easiness of producing graphene with a good crystalline structure. According to the inventors' study, the graphene product thus obtained, however, has a limitation in its usage for electronic elements or electrode materials several scores of micrometers or less in size.

The epitaxy method is separating carbon from the inside of silicon carbide (SiC) crystals to the surface to form a honeycomb structure peculiar to graphene. This method allows production of graphene films with uniform crystallinity. According to the inventors' study, the graphene thus obtained, however, is inferior in electrical characteristics to those obtained by the other methods, and the silicon carbide (SiC) wafer is very expensive.

The method using a reducing agent involves oxidizing graphite, pulverizing the oxidized graphite to form oxidized graphene, and reducing the oxidized graphene into graphene using a reducing agent such as hydrazine. Advantageously, this method involves a simple and low-temperature process. According to the inventors' study, the oxidized graphene, however, may not be completely reduced in a chemical way, leaving defects on the graphene, consequently with poor electrical characteristics of graphene.

The method using a metallic catalyst allows production of high-quality and large-area graphene films superior in electrical characteristics to graphene films obtained by the other methods. This metallic catalyst method involves forming a metallic catalyst layer on a substrate to aid growth of graphene, and then performing deposition of a gas containing carbon atoms on the metallic metal layer at a high temperature to form a graphene film.

According to the inventors' study, the metallic catalyst method produces high-quality and large-area graphene films but adversely involves a complicated and inefficient process. This method is complicated because it includes a process of forming a metallic catalyst layer, that is, forming (depositing) a metallic catalyst layer, such as of nickel (Ni), on a substrate, and a process of removing the metallic catalyst layer after the growth of graphene. The method is also inefficient because there is the difficulty in recovering the metallic catalyst. Furthermore, the method does not allow an easiness of controlling the graphene film in regard to thickness and electrical characteristics such as electrical conductivity.

### SUMMARY

The present disclosure is directed to a method for preparing carbon materials, carbon materials prepared from the method, and a stacked product containing the carbon materials, in which the carbon materials such as graphene or the like can be prepared in a simple non-catalyst process using a polymer alone through stabilization and carbonization without a need for using a metallic catalyst, and the carbon materials are easy to control in thickness and electrical characteristics.

In an exemplary embodiment, a method for preparing carbon materials comprises: forming a polymer layer comprising a polymer; stabilizing the polymer layer to have a cyclized aromatic structure of carbon atoms in the polymer; and carbonizing the stabilized polymer layer.

In an exemplary embodiment, the forming a polymer layer involves applying a polymer solution to form a film-shaped polymer layer. The polymer solution comprises about 0.01 to about 20.0 wt. % of the polymer.

In an exemplary embodiment, the stabilizing comprises at least one of the following (a) to (d): (a) heat-treating the polymer at a temperature of about 400° C. or below in the air, oxygen or vacuum atmosphere; (b) treating the polymer with alkali; (c) treating the polymer with at least one physical treatment selected from plasma, radioactive radiation, ultraviolet radiation, and microwave; and (d) causing the polymer to react with a comonomer.

In an exemplary embodiment, carbon materials are prepared by the preparation method according to the embodiment and comprises at least one graphene layer.

In an exemplary embodiment, the carbon materials comprise 1 to 300 graphene layers.

In an exemplary embodiment, a product of carbon materials comprises a substrate; and the carbon materials prepared by the method according to the embodiments formed on the substrate.

According to the embodiments, carbon materials may be easily prepared in a simple and efficient process without using a metallic catalyst. Further, the carbon materials may be easy to control in regard to thickness and electrical characteristics.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a schematic view of a preparation process according to an exemplary embodiment illustrating a change of the polymer structure in the respective steps;

FIG. 2 is a graph showing the result of evaluation on the thickness of graphene films (carbonized at about 1,000° C.) prepared according to an example depending on the polymer concentration;

FIG. 3 is a graph showing the result of evaluation on the electrical conductivity of graphene films (carbonized at about 1,000° C.) prepared according to an example depending on the polymer concentration;

FIG. 4 is a graph showing the result of Raman spectrum analysis on graphene films (carbonized at about 1,000° C.) prepared according to an example depending on the polymer concentration;

FIG. 5 shows an image of a graphene film (carbonized at about 1,000° C.) having a polymer content of about 2.0 wt. % according to an example;

FIG. 6 is a graph showing the result of evaluation on the thickness of graphene films (carbonized at about 1,200° C.) prepared according to an example depending on the polymer concentration;

FIG. 7 is a graph showing the result of evaluation on the electrical conductivity of graphene films (carbonized at about 1,200° C.) prepared according to an example depending on the polymer concentration; and

FIG. 8 is a graph showing the result of Raman spectrum analysis on graphene films (carbonized at about 1,200° C.) prepared according to an example depending on the polymer concentration.

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

In the embodiments, carbon materials are not specifically limited so long as that they have a cyclized aromatic structure of carbon atoms. Carbon atoms may be arranged in a six-membered cyclized aromatic structure. The carbon materials may be selected from, for example, two-dimensional graphene, one-dimensional graphite, or zero-dimensional fullerene.

According to the embodiments, carbon materials may be produced in a simple and efficient way. The carbon materials prepared according to the embodiments are not limited in shape. For example, the carbon materials may be of a film (or sheet) form. Film (or sheet) type carbon materials may have a nanometer (nm)-sized thickness. The carbon materials may also be of a line form. For example, the carbon materials may be provided in a line form on a substrate by a selective coating process. The line-type carbon materials may have nanometer (nm)-sized thickness and width.

The method for preparing carbon materials according to the embodiments allows a simple way of preparing carbon materials in a non-catalyst process through a stabilization reaction and a carbonization without using a metallic catalyst. The stabilization reaction is to induce a cyclized aromatic structure of carbon atoms.

More specifically, the method for preparing carbon materials according to an exemplary embodiment may include forming a polymer layer comprising a polymer, stabilizing the polymer layer to make the carbon atoms in the polymer have a cyclized aromatic structure, and carbonizing the stabilized polymer layer. Respective steps are described as follows.

Formation of Polymer Layer

First, a polymer layer is formed. The polymer layer includes at least a polymer, and optionally a solvent. The method for forming (preparing) the polymer layer is not specifically limited. The polymer layer may be formed by coating. The polymer layer may be formed by applying a polymer solution on a substrate. In an exemplary embodiment, the polymer solution does not only refer to a polymer dissolved in a solvent. The polymer solution may include, for example, a polymer liquid melted by heat. The polymer solution may have such a viscosity as can be applied by coating.

The polymer solution may be a liquid comprising a polymer and a solvent. In an exemplary embodiment, the carbon materials are controllable in coating thickness and electrical characteristics (e.g., electrical conductivity, etc.) by regulating the concentration of the polymer. More specifically, the lower concentration of the polymer may produce a coating of carbon materials with the lower thickness. Further, an appropriate control of the polymer in a low concentration range allows production of carbon materials having high electrical characteristics (e.g., electrical conductivity, etc.).

In an exemplary embodiment, the polymer layer may include about 0.01 to about 20.0 wt. % of polymer. In other words, the polymer layer may be formed from a polymer solution including a polymer and a solvent, and contains the polymer in a content (concentration) of about 0.01 to about 20.0 wt. % with respect to the total weight of the polymer solution. With an extremely low content of the polymer less than about 0.01 wt. %, the coating of carbon materials may be too thin to separate from the substrate, and have a low compactness of carbon atoms, causing a deterioration in the electrical characteristics such as electrical conductivity, etc. With an extremely high content of the polymer exceeding about 20.0 wt. %, a great amount of amorphous carbon may remain after carbonization to cause a deterioration in the electrical characteristics such as electrical conductivity, etc. Hence, in consideration of electrical characteristics and thickness, the polymer may be contained in an amount of about 0.01 to about 20.0 wt. % in the polymer solution.

The polymer layer is not specifically limited in thickness. For example, the thickness of the polymer may be from about 1 nm to about 100 μm. The polymer layer may have a nanometer-scale thickness, about 1,000 nm or less. Also, the polymer layer may be coated on a substrate, for example, in a film (or sheet) or line form. In this context, the term “line” as used herein refers to at least one line having a defined width and a defined thickness, which line may be formed along the x-axis (horizontal) or y-axis (vertical), or along the x- and y-axes on the x-y plane of the substrate. There is no limit in the orientation and the number of lines. The line may have nanometer-scale width and thickness, for example, about 1 nm to about 1,000 nm, about 1 nm to about 100 nm in width and height.

In an exemplary embodiment, the polymer layer is a film type polymer nanofilm. The polymer nanofilm is formed (prepared) from a polymer into a film with a nano-scale thickness, about 1,000 nm or less. The polymer nanofilm may have a thickness of, for example, about 1 to about 1,000 nm, about 1 to about 300 nm, or about 1 to about 100 nm. The thickness of the polymer nanofilm is controllable by regulating the polymer concentration (content), the molecular weight of the polymer, and/or the number of coatings of the polymer.

In the embodiments of the present invention, the polymer is not specifically limited and may be selected from natural polymers or synthetic polymers so long as it contains carbon atoms. For example, the polymer may be selected from a homopolymer or copolymer comprising at least one selected from polyacrylonitriles and polyolefins, or a mixture comprising at least one of celluloses, lignins, natural polymers and pitch. In case of using heat-treatment for stabilization, the above-mentioned polymers may be advantageously used to induce a stabilization reaction at a low temperature.

The solvent is not specifically limited so long as it has such a viscosity as to dilute the polymer, which may be thereby applied. For example, the solvent may be selected from water, organic solvent, or the like. The organic solvent may include, but not specifically limited to, at least one selected from alcohols, glycols, ketones, formamides, etc. More specifically, the organic solvent may be at least one selected from methanol, ethanol, isopropanol, methylene glycol, ethylene glycol, methylethylketone (MEK), dimethylformamide (DMF), etc.

As described above, the polymer layer may be formed by applying a polymer solution on a substrate. Herein, there is no limit in the coating technique and the number of coatings. For example, the polymer solution may be applied at least once by at least one method selected from spin coating, dip coating, bar coating, self assembly, spray, etc. As for a selective coating method in a specific area, the polymer solution may be applied, for example, using at least one method selected from ink-jet printing, gravure, gravure-offset, flexography, screen-printing, etc.

Among these coating methods, if using the spin coating or dip coating method, for example, almost the whole area of the substrate may be coated with the polymer solution to form a film type polymer layer such as a large-area polymer nanofilm. Further, a selective coating, such as ink-jet printing, gravure, etc., is partly coating the substrate with the polymer solution to form a line type polymer layer. This method may be advantageously adopted for carbon materials which are used as, for example, electrodes.

The substrate is not specifically limited so long as it supports the polymer layer and has a thermal stability during carbonization. The substrate may be any substrate consisting of a metal element in any one of Groups 2 to 5, such as, for example, at least one crystal selected from Al₂O₃, ZnO, GaN, GaAs, etc. Preferably, the substrate consists of silicon (Si) and is selected from a silicon substrate or a silicon compound substrate. The silicon compound substrate may contain a silicon compound selected from, for example, silicon oxide, quartz, silicon nitride, silicon carbide, etc.

Stabilization

In this context, the term “stabilization” as used herein refers to making the polymer have a cyclized aromatic structure of carbon atoms (cyclization of carbon atoms) prior to carbonization. A plurality of carbon atoms may be arranged to form a polycyclic structure through stabilization. Though not specifically limited, one cyclized aromatic structure contains, for example, 5 to 7 carbon atoms connected to one another through covalent bonds. The polymer may be a six-membered cyclized aromatic structure of 5 to 6 carbon atoms.

The stabilization may be achieved through thermal, physical and/or chemical treatment. The stabilization may be carried out in a process including at least one of the following steps (a) to (d): (a) heat-treating the polymer (heat-treatment); (b) treating the polymer with alkali (alkali treatment); (c) treating the polymer with a physical means (physical treatment); and (d) causing the polymer to react with a comonomer (chemical treatment).

The above mentioned stabilization i.e. the steps (a) to (d) may be performed prior to carbonization, and depending on the respective steps, before or after formation of the polymer layer (being coated on the substrate).

The step (a) (heat-treatment) may be carried out in the air, oxygen, or vacuum atmosphere. The step (a) may be performed before formation of the polymer layer, or preferably after formation of the polymer layer. For example, a film type polymer layer (polymer nanofilm) may be formed on the substrate and then put in an electric furnace to undergo heat treatment.

In the step (a), the heat-treatment temperature is not specifically limited so long as it is a cyclization temperature of carbon atoms or higher, and a carbonization temperature or lower. The heat-treatment temperature may be about 400° C. or below. A high temperature exceeding about 400° C. may cause carbonization before stabilization (cyclization of carbon atoms) occurs. Hence, the step (a) may be carried out at a temperature of, for example, about 100 to about 400° C. The heat-treatment temperature lower than about 100° C. may result in a failure of stabilization (cyclization of carbon atoms), consequently with a deterioration in the characteristics of carbon materials. The heat-treatment temperature may be about 150 to about 400° C. Though not specifically limited, the heat-treatment of the step (a) may last about 40 minutes to about 4 hours.

The step (b) (alkali treatment) involves impregnating a polymer layer in an alkali solution. The alkali solution may be an aqueous alkali solution, an organic alkali solution, or a mixture of these solutions. The alkali solution may be a strong alkaline solution at pH 9 or above. The step (b) may be impregnating a polymer layer in an alkali solution, such as, for example, potassium hydroxide (KOH) or sodium hydroxide (NaOH) at the room temperature or above for about 10 minutes to about 5 hours. The impregnation in the alkali solution may cause a chemical stabilization reaction of the polymer to cyclize the carbon atoms in the polymer.

The step (c) (physical treatment) involves applying on the polymer at least one physical means selected from plasma, ion beam, radioactive lays, ultraviolet radiation, or microwave. The step (c) may be carried out prior to formation of the polymer layer, but preferably after formation of the polymer layer. The above-mentioned physical treating means are not limited in wavelength or intensity as long as they may induce the stabilization reaction.

The step (d) (chemical treatment) involves causing a polymer to react with a comonomer. The step (d) may be carried out by adding a comonomer to a polymer solution to cause the reaction after formation of the polymer layer, preferably prior to formation of the polymer layer (prior to coating the substrate). The comonomer may be used, but not specially limited to, in an amount of about 0.01 to about 20 wt. % with respect to the total weight of the polymer solution.

The comonomer may be any comonomer with no certain limit so long as it alters the structure of the polymer chain or crosslinks the polymer chain to induce a stabilization reaction (cyclization of carbon atoms). For example, the comonomer may be at least one selected from methyl acrylate, methacrylic acid, acrylic acid, itaconic acid, methyl methacrylate, itaconic acid-methyl acrylate, etc.

In the embodiments, the stabilization step, for example, steps (a) to (d) may induce a cyclized aromatic structure of carbon atoms and stabilize the polymer in order to prevent a cleavage of the polymer chain during high-temperature carbonization. The stabilization step may allow preparation of carbon materials (e.g., graphene, etc.) with high-quality physical, chemical and electrical characteristics after carbonization.

Carbonization

Following the stabilization reaction induced, the polymer layer is carbonized. Carbonization is carried out under conditions, including an inert gas atmosphere containing argon, nitrogen, etc., an inert gas atmosphere containing at least one of hydrogen, etc., a vacuum atmosphere, or at least one of these atmospheres. The carbonization temperature may be about 400° C. or above. The carbonization temperature below about 400° C. may make carbonization difficult to occur and remain a large amount of amorphous carbon, thereby deteriorating the electrical characteristics of the carbon materials. A very high carbonization temperature may cause volatilization of carbon. Hence, the carbonization step may be carried out under the above atmosphere condition, for example, at a temperature of about 400 to about 3,000° C. Besides, the carbonization may be performed by putting the polymer layer under induced stabilization into a carbonizing furnace, for example, for about 10 minutes to about 20 hours.

The carbonization step may include at least a carbonization process (a first carbonization) under the above atmosphere at a temperature of about 400 to about 1,800° C. The first carbonization in the above temperature may allow preparation of high-quality carbon materials (graphene, etc.). The carbonization step may further include a carbonization process (a second carbonization) under the above atmosphere at a temperature of about 1,800 to about 3,000° C. The second carbonization process in this temperature may remove the graphene of defects or functional groups bonded to carbon atoms, thereby enhancing crystallinity. In this manner, more improved high-quality carbon materials (graphene, etc.) may be produced. Accordingly, to prepare high-quality carbon materials, the carbonization step may include at least the first carbonization process performed at about 400 to about 1,800° C., and then the second carbonization process at about 1,800 to about 3,000° C.

For the use of carbon materials in a wide range of applications, a doping gas may be injected into the furnace during carbonization. The doping gas is not specifically limited so long as it surface-modifies the carbon materials. The doping gas may include ammonia gas, or the like to dope the surface of the carbon materials with, for example, nitrogen.

To enhance the characteristics of the carbon materials, the carbonization step may involve performing carbonization along with injection of a carbon-containing gas into the furnace. Here, the carbon-containing gas may be a gas containing carbon atoms in the molecules, such as, for example, a hydrocarbon gas having 1 to 5 carbon atoms (C1 to C5). The example of the carbon-containing gas may include at least one hydrocarbon gas selected from acetylene, ethylene, methane, etc.

Further, a typical after-treatment step may follow the carbonization step. For example, an additional step may be carried out to peel (remove) the carbonized carbon materials off the substrate. After removal of the carbon materials from the substrate, a step of transferring the removed carbon materials to a separate substrate (hereinafter, referred to as “second substrate”) may be further carried out.

Here, the second substrate (transfer substrate) is not specifically limited and may be selected from, for example, a metal substrate, a ceramic substrate, a plastic substrate, etc. The second substrate may be a constituent of products to which the carbon materials according to the embodiments applied. For example, the second substrate may be a component constituting electrical/electronic elements, optical elements, filter elements, cells, etc.

The preparation method according to the embodiments may allow preparation of high-quality carbon materials (e.g, graphene, graphite, etc.) in a simple and efficient process using a polymer alone without a need for using a metallic catalyst. More specifically, the preparation method not requiring the use of a metallic catalyst may realize a simple and efficient process, which does not need a preparation process of a metallic catalyst layer by forming (depositing) a metallic catalyst layer on the substrate, a process of removing the metallic catalyst layer after carbonization, and a recovery process of the metallic catalyst. Accordingly, the carbon materials according to the embodiments may be available at a low production cost.

The preparation method according to the embodiment also may make it easier to control the carbon materials in regard to thickness and electrical characteristics such as electrical conductivity, etc. More specifically, when using a polymer solution consisting of a polymer and a solvent, the concentration (content) of the polymer may be regulated to control the thickness and the electrical characteristics (e.g., electrical conductivity, etc.) of the carbon materials. In other words, as described above, the carbon materials may be provided with high electrical characteristics (e.g., electrical conductivity, etc.) by appropriately regulating the concentration of the polymer in a low range. The concentration of the polymer of about 0.01 to about 20.0 wt. %, specifically about 0.1 to about 20.0 wt. % may result in production of carbon atoms with high electrical characteristics (e.g., electrical conductivity, etc.). For example, such carbon materials may have an electrical conductivity at least about 100 S/cm, specifically at least about 200 S/cm, more specifically at least about 400 S/cm.

In the preparation method according to the embodiments, the concentration of the polymer controlled in a low range may secure high transparency, allowing the carbon materials to be useful as transparent electrodes, or the like. The preparation method also may allow preparation of large-area carbon materials. More specifically, a polymer solution may be applied on a large-area substrate into a film by coating, to produce large-area carbon materials.

On the other hand, the carbon materials according to the embodiments, which are prepared by the preparation method according to the embodiments, may consist of at least one graphene layer having a plane (two-dimensional) cyclized aromatic structure of carbon atoms. Here, the carbon materials may contain a zero-, one-, or two-dimensional cyclized aromatic structure of carbon atoms (specifically, a six-membered ring structure of carbon atoms). More specifically, the carbon materials may be selected, as described above, from two-dimensional graphene, one-dimensional graphite, zero-dimensional fullerene, etc. In the embodiments, the carbon materials may be a graphene including one to three hundreds of the single-layered graphene layers.

In addition, the carbon materials in the embodiments may be provided in a film or line form, with a nanometer-scale thickness of about 1,000 nm or less. The thickness of the carbon materials may be from about 1 to about 300 nm, specifically about 1 to about 100 nm. The carbon materials in the form of the film or line may be about 1 nm to about 1 m in length (horizontal and vertical lengths). Further, the carbon materials according to the embodiments may have an electrical conductivity of about 1 to about 2,000 S/cm. The electrical conductivity of the carbon materials may be acquired within the above range by controlling the polymer concentration, the carbonation temperature, or the like.

The stacked product of carbon materials according to the embodiments may include a substrate; and carbon materials formed on the substrate. Here, the carbon materials formed on the substrate may be prepared according to the embodiments as described above. The substrate may be a substrate used in the coating process, or a separate substrate. More specifically, the substrate constituting the stacked product of carbon materials according to the embodiments may be the substrate used as a support body in putting a polymer solution for coating to constitute the stacked product without being peeled, or may be the above-described second substrate as a separate substrate.

In the embodiments, the substrate constituting the stacked product of carbon materials includes, but not specifically limited to, for example, at least one selected from a metal substrate, a ceramic substrate, a plastic substrate, etc., which substrate may be used alone or in combination with another as a laminate. The ceramic substrate as used herein may include, but not specifically limited to, a substrate containing Al₂O₃, ZnO, GaN, GaAs, etc.; a Si-containing substrate (i.e., silicon substrate, silicon compound substrate, etc.); or a metal oxide substrate containing ITO (indium tin oxide) or IZO (indium zinc oxide). The plastic substrate may include a rigid or flexible substrate.

The carbon materials (and a stacked product comprising the same) according to the above-described embodiments may be used in a wide range of applications, such as, for example, electrical/electronic elements, optical elements, filter elements, cell materials, gas storage materials (for hydrogen, methane, carbon dioxide, etc.), gas barrier materials, and so forth. As for cell materials, for example, the carbon materials may be used as electrode, catalyst, catalyst substrate, separator, and gas diffusion layer for solar cells, secondary cells, super-capacitors, fuel cells, etc.

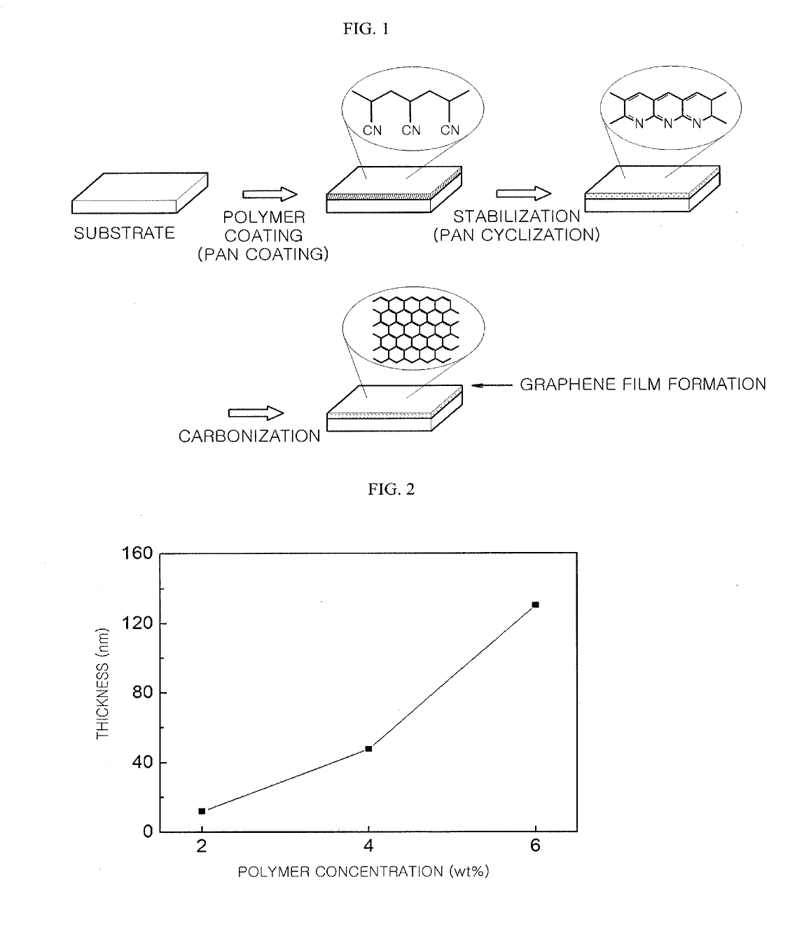

FIG. 1 is a schematic view of a preparation process according to an exemplary embodiment illustrating a change of the polymer structure in the respective steps.

### EXAMPLE 1

Preparation of Polymer Nanofilm

Polyacrylonitrile (PAN) is dissolved in a polar organic solvent, dimethylformamide (DMF), using an agitator for one hour to prepare a polymer solution (PAN solution). To determine the characteristics depending on the concentration of the polymer (PAN), the concentration (content) of the polymer was varied as about 0.5 wt. %, about 1.5 wt. %, about 2.0 wt. %, about 4.0 wt. % and about 6.0 wt. % with respect to the total weight of the polymer solution. Subsequently, the polymer solution for each polymer concentration is applied on an oxidized silicon substrate as thick as about 300 nm with a spin coating machine. Each polymer solution used for spin coating is about 100 μl in volume, and the rotation rate of the spin coating machine is about 500 rpm for about 5 seconds and then about 4,000 rpm for about 90 seconds until the completion of spin coating. The size of the silicon substrate measured is about 1.5 cm×about 1.5 cm.

Stabilization

To induce the stabilization reaction (cyclization of carbon atoms) of the polymer, the polymer nanofilm prepared above is put in an oven for heat treatment in the air atmosphere at about 250° C. for about 2 hours.

Carbonization

The polymer nanofilm subject to the stabilization reaction is put into a furnace for carbonization. In the gas atmosphere using a mixed gas of argon and oxygen injected at a rate of about 2,000 sccm (cm³/min), the polymer nanofilm is heated to about 1,000° C. at a rate of about 5° C./min and then carbonized at the raised temperature of about 1,000° C. for about one hour to make a graphene film.

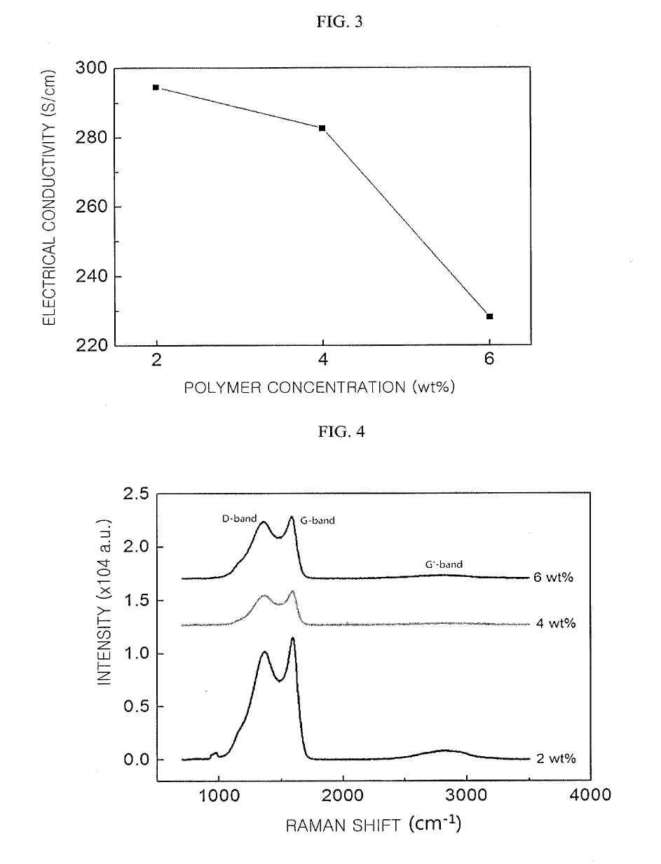

The graphene film thus obtained is evaluated in regard to thickness, electrical conductivity, and crystallinity. The thickness is measured with an atomic force microscope (AFM). The measurement results of the thickness are presented in FIG. 2. The electrical conductivity is calculated from the film thickness and the surface resistance is measured by the four-probe method. The measurement results of the electrical conductivity are presented in FIG. 3. The crystallinity is determined by Raman spectroscopic analysis. The results of the analysis are presented in FIG. 4. Here, FIGS. 2, 3 and 4 show the evaluation results for the graphene films each prepared from a polymer solution with a polymer concentration of about 2.0 wt. %, about 4.0 wt. %, or about 6.0 wt. %.

As can be seen from FIG. 2, each graphene film has a nanometer-scale thickness, more specifically, of about 10 to about 140 nm. The thickness of the graphene film increases with an increase in the concentration of the polymer.

Referring to FIG. 3, the electrical conductivity of the graphene film increases with a decrease in the concentration of the polymer. The reason of this result is that the less amorphous carbon is formed during the carbonization process with the less thickness of the polymer nanofilm prepared by spin coating. Particularly, in this example, the electrical conductivity is as high as about 280 S/cm or above when the concentration of the polymer is about 4.0 wt. % or less, that is, about 2.0 wt. % and about 4.0 wt. %.

As shown in FIG. 4, in determination of the crystallinity by Raman spectroscopic analysis, the G′-band peak observed at 2,680 cm⁻¹ appears only when using the polymer solution having a low polymer concentration (about 2.0 wt. %). The graphene film prepared has the characteristics of graphene and consists of about 10 to about 15 layers of graphene.

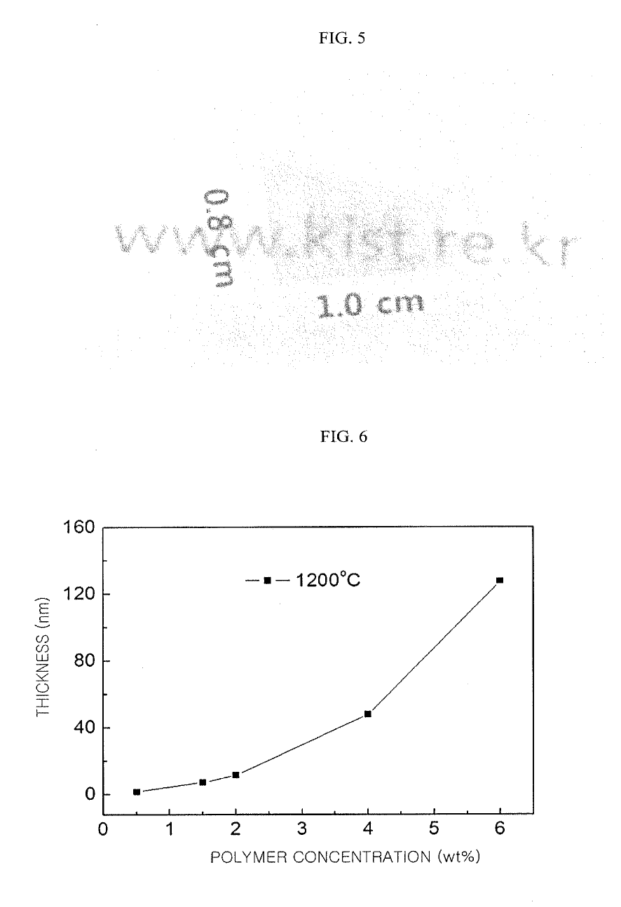

The graphene film thus obtained is peeled off the silicon substrate and then transferred onto a corning glass. FIG. 5 shows an image of the graphene film transferred to the corning glass. The graphene film in FIG. 5 is prepared from a polymer solution having a polymer concentration of about 2.0 wt. %. As can be seen from FIG. 5, the graphene film has a high transparency.

### EXAMPLE 2

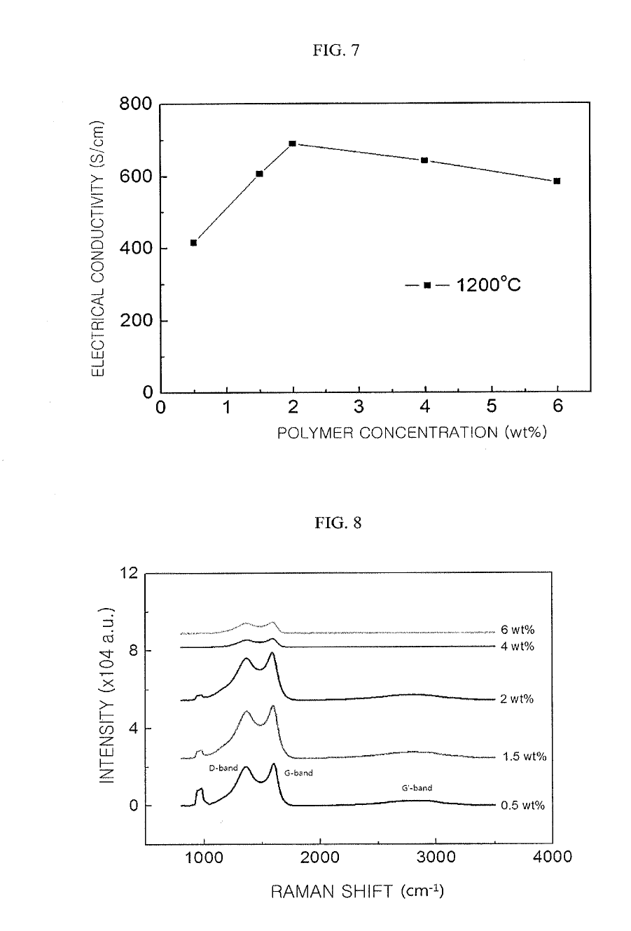

The procedures are performed in the same manner as described in Example 1, excepting that the carbonization temperature is varied from about 1,000° C. to about 1,200° C. to prepare graphene films each with a polymer concentration of about 0.5 wt. %, about 1.5 wt. %, about 2.0 wt. %, about 4.0 wt. %, or about 6.0 wt. %. In the same manner as described in Examples 1, the graphene films thus obtained are evaluated in regard to thickness, electrical conductivity, and crystallinity. The measurement results are presented in FIGS. 6, 7 and 8. FIG. 6 shows the evaluation results on the thickness of the graphene films according to Example 2. FIG. 7 shows the evaluation results on the electrical conductivity, and FIG. 8 shows the evaluation results on the crystallinity.

A comparison between FIGS. 2 and 6 reveals that the carbonization temperature hardly affect the thickness of the graphene film and that the lower concentration of the polymer results in production of graphene films with a fine thickness. As shown in FIG. 6, the use of a polymer solution having a low polymer concentration (0.5 wt. %) produces a graphene film with a fine thickness of about 1.0 nm.

A comparison between FIGS. 3 and 7 shows that unlike the thickness, the electrical conductivity is dependent upon the carbonization temperature. In other words, an increase in the carbonization temperature results in an enhanced electrical conductivity, which is increased by at least about 230% in maximum up to about 400 S/cm or above at a same polymer concentration. The reason of this is that amorphous carbon is eliminated during the high-temperature carbonization process.

As shown in FIG. 8, even in the case where the carbonization temperature is about 1,200° C., the G′-band peak observed at 2,680 cm⁻¹ appears when using a polymer solution having a low polymer concentration (about 0.5 wt. %, about 1.5 wt. %, about 2.0 wt. %, or less). Further, the graphene films turns out to have the characteristics of graphene.

From the above-specified results, it may be seen that a stabilization reaction induced prior to carbonization of polymer nanofilms allows preparation of graphene films in a simple process without a need for using a metallic catalyst. Particularly, the graphene films are controllable in regard to thickness and electrical conductivity by regulating the concentration of the polymer, achieving a high electrical conductivity from a low concentration of the polymer. Further, such a high electrical conductivity and a high transparency may make it possible to use the graphene films as transparent electrodes.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A method for preparing carbon materials comprising:
forming a polymer layer comprising a polymer;
stabilizing the polymer layer to have a cyclized aromatic structure of carbon atoms in the polymer; and
carbonizing the stabilized polymer layer,
wherein the polymer layer is formed by applying a polymer solution comprising a polymer and a solvent on a substrate, the polymer solution comprises about 0.01 to about 20.0 wt. % of the polymer.

2. The method according to claim 1, wherein the polymer layer is a polymer nanofilm.

3. The method as according to claim 2, wherein the polymer nanofilm has a thickness of about 1 to about 300 nm.

4. The method according to claim 1, wherein the polymer is selected from a homopolymer or copolymer of at least one selected from polyacrylonitriles, polyolefins, or a mixture of at least one selected from celluloses, lignins, natural polymers, and pitch.

5. The method according to claim 1, wherein the stabilizing comprises at least one selected from the following (a) to (d):
(a) heat-treating the polymer at a temperature of about 400° C. or below in the air, oxygen or vacuum atmosphere;
(b) treating the polymer with alkali;
(c) treating the polymer with at least one physical means selected from plasma, radioactive radiation, ultraviolet radiation, and microwave; and
(d) causing the polymer to react with a comonomer.

6. The method according to claim 5, wherein the heat-treating is performed at a temperature of about 150 to about 400° C.

7. The method according to claim 5, wherein the polymer is impregnated in an alkali solution at pH 9 or above.

8. The method according to claim 5, wherein the comonomer is at least one selected from the group consisting of methylacrylate, methacrylic acid, acrylic acid, itaconic acid, methyl methacrylate, and itaconic acid-methyl acrylate.

9. The method according to claim 1, wherein the polymer layer is carbonized at a temperature of about 400 to about 1,800° C.

10. The method according to claim 9, wherein the polymer layer is carbonized at a temperature of about 1,800 to about 3,000° C.

11. The method according to claim 1, wherein the polymer layer is carbonized along with an injection of a doping gas.

12. The method according to claim 11, wherein the doping gas comprises an ammonia gas.

13. The method according to claim 1, wherein the polymer layer is carbonized along with an injection of a carbon-containing gas.

14. The method according to claim 13, wherein the carbon-containing gas comprises a C1-C5 hydrocarbon gas.

15. Carbon materials prepared by the method according to claim 1, comprising at least one graphene layer formed of a cyclized aromatic structure of carbon atoms.

16. The carbon materials according to claim 15, wherein the carbon materials comprise 1 to 300 graphene layers.

17. The carbon materials according to claim 15, wherein the carbon materials are provided in a film or line form, and have about 1 nm to about 1 m in length.

18. A product of carbon materials according to claim 15 comprising:
a substrate; and the carbon materials formed on the substrate.
